(19) United States
(12) Patent Application Publication
(10) Pub. No.: US 2010/0050908 A1
(43) Pub. Date: Mar. 4, 2010

(54) FISHING PLATFORM

(76) Inventor: Johnny Moore, JR., Jonesboro, AR (US)

Correspondence Address: Intellipex PLLC, 30200 Telegraph Road, Suite 245, Bingham Farms, MI, 48025, US

(21) Appl. No.: 12/546,723

(22) Filed: Aug. 25, 2009

Related U.S. Application Data
(60) Provisional application No. 61/092,805, filed on Aug. 29, 2008.

(51) Int. Cl. A01K 97/22

(52) U.S. Cl. 108/33

(57) ABSTRACT

A fishing platform includes a first half casing, a foldable sitting arrangement, a second half casing, and a securing mechanism. The foldable sitting arrangement is adapted to be disposed on the first half casing. The second half casing comprises a plurality of compartments adapted to store a plurality of articles associated with a fishing activity. The securing mechanism is adapted to removably secure the first half casing to the second half casing in a stacked arrangement of the first half casing and the second half casing for allowing the fishing platform to attain one of an open state and a closed state. The first half casing and the second half casing are capable of being placed juxtaposed to each other on a shore area with the sitting arrangement in an unfolded state for allowing an individual to be seated for fishing in the open state of the fishing platform.

### CROSS REFERENCE TO RELATED APPLICATIONS

The present disclosure claims priority under 35 United States Code, Section 119 on the U.S. Provisional Patent Application No. 61/092,805 filed Aug. 29, 2008 the disclosure of which is incorporated by reference.

### FIELD OF THE DISCLOSURE

The present disclosure generally relates to fishing equipments, and, more particularly to a fishing platform that may provide pleasant fishing experience to an individual.

### BACKGROUND OF THE DISCLOSURE

Fishing is generally one of a favorite pastime activity performed by individuals during their free time. One common example of a fishing activity is catching fish with the help of a fishing rod at a fishing site, such as a river shore. During such fishing activity, an individual needs to manually hold the fishing rod. The individual further stays in a standing posture by holding the fishing rod during such fishing activity. A constant standing posture of the individual for holding the fishing rod during the fishing activity may make such fishing activity tiring and boring.

Moreover, for such fishing activity, an individual needs to carry a plurality of articles associated with the fishing activity to the fishing site. For example, for carrying out fishing with the help of the fishing rod, the individual needs to carry articles, such as fishing rods, fishing reels, tackles, and creel to the fishing site. Additionally, in case of a longer fishing trip, the individual may carry other articles, such as drinks, umbrella, radio, and flashlight, for making the fishing activity enjoyable. Generally, for carrying such articles, the individual may use a carrier, such as a bag or a container. The use of such carrier for carrying the articles does not provide systematic arrangement for storing the articles, and accordingly the access of the articles may become cumbersome and time consuming.

Accordingly, there exists a need for precluding tiring and boring aspects associated with a fishing activity. Also, there exists a need for facilitating an individual with easy carrying and accessing of a plurality of articles associated with the fishing activity.

### SUMMARY OF THE DISCLOSURE

In view of the forgoing disadvantages inherent in the prior-art, the general purpose of the present disclosure is to provide a fishing platform, to include all advantages of the prior art, and to overcome the drawbacks inherent in the prior art.

Accordingly, an object of the present disclosure is to provide a fishing platform which enables an individual to be seated during a fishing activity.

Another object of the present disclosure is to provide a fishing platform capable of providing easy storage and accessibility of a plurality of articles associated with a fishing activity, during the fishing activity.

To achieve the above objects, the present disclosure provides a fishing platform. The fishing platform comprises a first half casing, a foldable sitting arrangement, a second half casing, and a securing mechanism. The first half casing comprises a first base portion, a first projecting portion extending from a periphery of the first base portion to define a hollow space between the first base portion and the first projecting portion. The foldable sitting arrangement is adapted to be received in the hollow space and disposed on the first base portion of the first half casing. The second half casing comprises a second base portion, a second projecting portion extending from a periphery of the second base portion, a plurality of compartments configured between the second base portion and second projecting portion.

The plurality of compartments of the second half casing is adapted to store a plurality of articles associated with a fishing activity. The securing mechanism is adapted to removably secure the first half casing to the second half casing in a stacked arrangement of the first half casing and the second half casing for allowing the fishing platform to attain one of an open state of the fishing platform and a closed state of the fishing platform. The first half casing and the second half casing are capable of being placed juxtaposed on a shore area with the sitting arrangement in an unfolded state for allowing an individual to be seated for fishing in the open state of the fishing platform. Further, the first half casing and the second half casing are secured to each other with the seating arrangement in the folded state and confined in the hollow space in the closed state of the fishing platform.

This together with the other aspects of the present disclosure, along with the various features of novelty that characterize the present disclosure, is pointed out with particularity in the claims annexed hereto and forms a part of the present disclosure. For a better understanding of the present disclosure, its operating advantages, and the specified object attained by its uses, reference should be made to the accompanying drawing and descriptive matter in which there are illustrated exemplary embodiments of the present disclosure.

### BRIEF DESCRIPTION OF THE DRAWINGS

The advantages and features of the present disclosure will become better understood with reference to the following detailed description and claims taken in conjunction with the accompanying drawings, and in which:

FIG. 1 illustrate a perspective view of a fishing platform in an open state of the fishing platform, in accordance with an embodiment of the present disclosure;

FIG. 2 illustrate a perspective view of the fishing platform in a closed state, in accordance with an embodiment of the present disclosure; and

FIG. 3 illustrate a perspective view of a first half casing of the fishing platform with a support arrangement, in accordance with an embodiment of the present disclosure; and

FIG. 4 illustrates an exemplary environment showing the fishing platform being utilized during a fishing activity, in accordance with an embodiment of the present disclosure.

Like reference numerals refer to like parts throughout the description of several views of the drawings.

### DETAILED DESCRIPTION OF THE DISCLOSURE

The exemplary embodiments described herein detail for illustrative purposes are subject to many variations in structure and design. It should be emphasized, however, that the present disclosure is not limited to a fishing platform, as shown and described. It is understood that various omissions and substitutions of equivalents are contemplated as circumstances may suggest or render expedient, but these are intended to cover the application or implementation without departing from the spirit or scope of the claims of the present disclosure. Also, it is to be understood that the phraseology and terminology used herein is for the purpose of description and should not be regarded as limiting.

The terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item.

The present disclosure provides a fishing platform for being used in a fishing activity. The fishing platform of the present disclosure is capable of proving a pleasant experience to an individual during the fishing activity. The fishing platform enables the individual to be seated during the fishing activity. Further, the fishing platform is capable of storing a plurality of articles associated with the fishing activity. Further, the fishing platform provides easy storage and accessing of the plurality of articles associated with the fishing activity. The fishing platform of the present disclosure may be manufactured by suitable materials such as a metal, fiberglass and plastic.

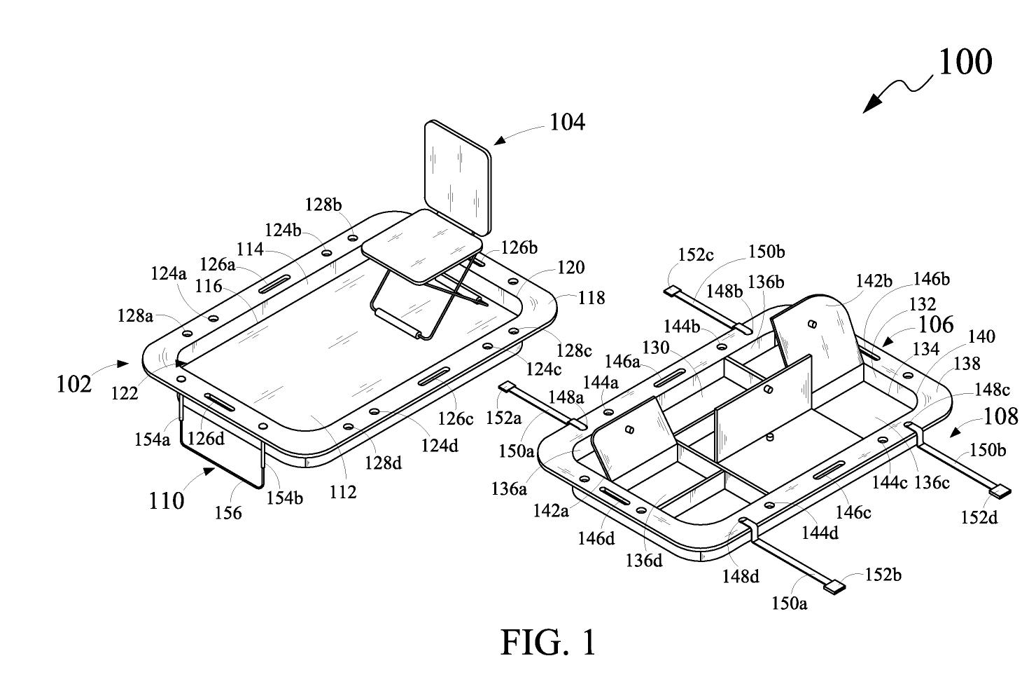

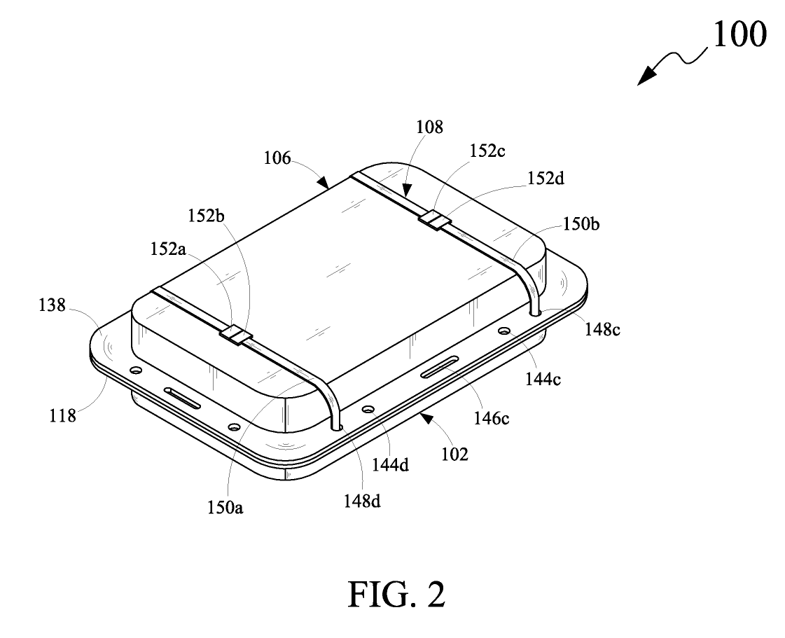

Referring to FIGS. 1 and 2, perspective views of a fishing platform 100 are illustrated, in accordance with an embodiment of the present disclosure. FIG. 1 illustrates a perspective view of the fishing platform 100 in an open state, and FIG. 2 illustrates a perspective view of the fishing platform 100 in a closed state.

As shown in FIG. 1, the fishing platform 100 includes a first half casing 102, a foldable sitting arrangement 104 adapted to be disposed on the first half casing 102, a second half casing 106, and a securing mechanism 108 adapted to removably secure the first half casing 102 to the second half casing 106. The fishing platform 100 further includes a support arrangement 110 adapted to be mounted on the first half casing 102.

The first half casing 102 of the fishing platform 100 includes a first base portion 112, and a first projecting portion 114 extending from a periphery 116 of the first base portion 112. The first half casing 102 further includes a first flange portion 118 extending from a top end portion 120 of the first projecting portion 114. In the present embodiment, the first projecting portion 114 extends perpendicularly from the periphery 116 of the first base portion 112. The first projecting portion 114 and the first base portion 112 define a hollow space 122 therebetween. The foldable sitting arrangement 104 is received in the hollow space 122.

In the present embodiment, the first half casing 102 is configured to assume a shape of an open rectangular container with a flange, such as the first flange portion 118, configured thereon. More specifically, the first base portion 112 is configured to assume a rectangular shape and the first projecting portion 114 extends perpendicularly from the periphery 116 of the first base portion 112 to define the open rectangular container shape of the first half casing 102. However, it may be evident to those skilled in the art that the first half casing 102 may be configured to assume other shapes apart from the open rectangular container, such as an open polygonal container, an open circular container, and an open oval container.

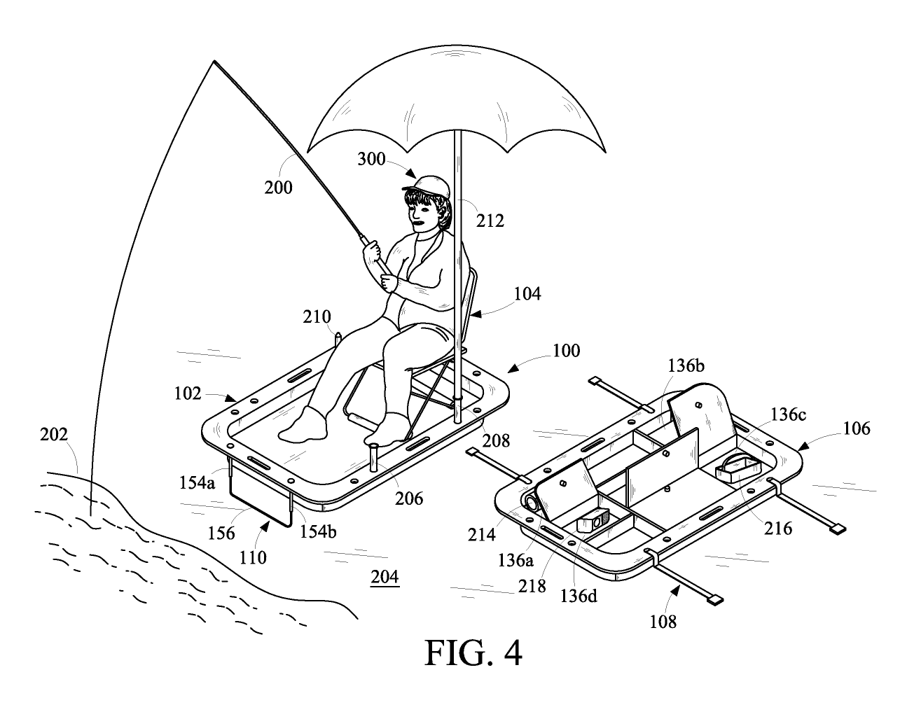

As shown in FIG. 1, the first flange portion 118 includes a plurality of mounting slots, such as mounting slots 124a, 124b, 124c, and 124d configured thereon. The each slot of the mounting slots 124a, 124b, 124c and 124d is adapted to hold at least one article associated with a fishing activity, which is further explained in detail in conjunction with FIG. 4. The term “at least one article associated with the fishing activity” used herein refers to any article used during the fishing activity. For example, the at least one article may include a fishing rod holder, an umbrella holder, and a drink holder capable of being mounted on the mounting slots 124a, 124b, 124c and 124d. Further, it may be evident to those skilled in the art that at least one article associated with the fishing activity may include other articles, such as a creel, an umbrella, a fishing rod, a tackle, a flashlight, and a radio, to be used for the fishing activity.

The first flange portion 118 of the first half casing 102 further includes a plurality of carrying slots, such as carrying slots 126a, 126b, 126c and 126d, configured thereon. The carrying slots 126a, 126b, 126c and 126d enable an individual in carrying the fishing platform 100 from one place to another, which is further explained in detail in conjunction with FIG. 2. Moreover, the first flange portion 118 of the first half casing 102 includes a plurality of securing slots, such as securing slots 128a, 128b, 128c, and 128d, configured on the first flange portion 118. The plurality of securing slots 128a, 128b, 128c, and 128d enable in securing the first half casing 102 to the second half casing 106, which is also further explained in detail in conjunction with FIG. 2.

As shown in FIG. 1, the foldable sitting arrangement 104 is disposed in the first half casing 102. More specifically, the foldable sitting arrangement 104 is disposed on the first base portion 112 of the first half casing 102. Further, in the present embodiment of the disclosure, the foldable sitting arrangement 104 is a foldable chair that is capable of attaining one of a folded state and an unfolded state. For example, as shown in FIG. 1, the foldable sitting arrangement 104 is disposed on the first base portion 112 of the first half casing 102 in the unfolded state. Moreover, the foldable sitting arrangement 104 is capable of attaining the folded state which is further explained in conjunction with FIG. 2.

In the present embodiment, the second half casing 106 of the fishing platform 100 includes a second base portion 130, a second projecting portion 132 extending from a periphery 134 of the second base portion 130, and a plurality of compartments, such as compartments 136a, 136b, 136c and 136d configured between the second base portion 130 and the second projecting portion 132. The compartments 136a, 136b, 136c and 136d are adapted to store a plurality of articles associated with the fishing activity. As explained herein, the plurality of articles associated with the fishing activity may include articles such as, the fishing rod holder, the umbrella holder, the drink holder, the creel, the umbrella, the fishing rod, the tackle, the flashlight, and the radio, which may be used during the fishing activity. The second half casing 106 further includes a second flange portion 138 extending from a top end portion 140 of the second projecting portion 132. Moreover, the second half casing 106 includes a plurality of flaps, such as flaps 142a and 142b, capable of closeably opening the compartments, such as the compartment 136a and 136b.

As shown in FIG. 1, the second flange portion 138 also includes a plurality of mounting slots, such as mounting slots 144a, 144b, 144c, and 144d configured thereon. The mounting slots 144a, 144b, 144c and 144d are adapted to hold at least one article associated with the fishing activity, which is further explained in conjunction with FIG. 4. The second flange portion 138 of the second half casing 106 further includes a plurality of carrying slots, such as carrying slots 146a, 146b, 146c, and 146d, configured thereon. The carrying slots 146a, 146b, 146c, and 146d enable the individual in carrying the fishing platform 100 from one place to another. Moreover, the second flange portion 138 of the second half casing 106 includes a plurality of securing slots, such as securing slots 148a, 148b, 148c, and 148d, configured on the second flange portion 138. The securing slots 148a, 148b, 148c, and 148d enable in securing the first half casing 102 to the second half casing 106, which is further explained in conjunction with FIG. 2.

As shown in FIG. 1, the second half casing 106 is configured to assume a shape of rectangular container with the compartments 136a, 136b, 136c and 136d, configured therein. In this embodiment, the second base portion 130 is configured to assume a rectangular shape. Further, the second projecting portion 132 extending perpendicularly from the periphery 134 of the second base portion 130 defines the rectangular container shape of the second half casing 106. However, it may be evident to those skilled in the art that the second half casing 106 may be also configured to assume other shapes apart from the rectangular container, such as a polygonal container, a circular container, and an oval container.

As explained herein, each of the first half casing 102 and the second half casing 106 is configured to assume the shape of the open rectangular container. Accordingly, the second half casing 106 may be placed over the first half casing 102, the first half casing 102 in a staked arrangement, as shown in FIG. 2. In the stacked arrangement of the first half casing 102 and the second half casing 106, the foldable sitting arrangement 104 may be confined in the hollow space 122 in the folded state.

Referring specifically to FIG. 2, a perspective view of the fishing platform 100 in a closed state is illustrated, in accordance with an embodiment of the present disclosure. As shown in FIG. 2, the first flange portion 118 of the first half casing 102 are aligned to the second flange portion 138 of the second half casing 106 thereon to attain the stacked arrangement. Further, in the stacked arrangement of the first half casing 102 and the second half casing 106, the plurality of slots configured on the first flange portion 118 align with the plurality of slots configured on the second flange portion 138. For example, the mounting slots 124a, 124b, 124c and 124d configured on the first flange portion 118 align with the mounting slots 144a, 144b, 144c and 144d configured on the second flange portion 138. In an exemplary representation of FIG. 2, the mounting slot 144d configured on the second flange portion 138 is shown as aligned with the mounting slot 124d (as shown in FIG. 1) configured on the first flange portion 118.

The fishing platform 100 in the closed state is easy for the individual to carry the fishing platform 100 form one place to another place. The carrying slots 126a, 126b, 126c and 126d configured on the first flange portion 118 also align with the carrying slots 146a, 146b, 146c and 146d configured on the second flange portion 138. For example, as shown in FIG. 2, the carrying slot 146c configured on the second flange portion 138 aligns with the carrying slot 126c (as shown in FIG. 1) configured on the first flange portion 118. Accordingly, the aligned carrying slots 146c and 126c allow an individual's hand to be received therethrough, and thereby allow the individual to carry the fishing platform 100 form one place to the another place. The securing mechanism 108 is adapted to removably secure the first half casing 102 to the second half casing 106 in the stacked arrangement thereof and thereby allowing the fishing platform 100 to attain one of the open state (as shown in FIG. 1) and the closed state (as shown in FIG. 2).

Referring again to FIG. 1, the securing mechanism 108 includes a pair of straps, such as straps 150a and 150b, and a plurality of connectors, such as connectors 152a, 152b, 152c and 152d configured at end portions of the straps 150a and 150b. For example, the connectors 152a and 152b are configured at end portions of the strap 150a. Similarly, the connectors 152c and 152d are configured at end portions of the strap 150b. In the present embodiment, the connectors 152a, 152b, 152c and 152d may be a belt clasp configured at the end portions of the straps 150a and 150b. However, it may be evident to a person skilled in the art that the securing mechanism 108 may include hook and loop fastener, instead of the connectors 152a, 152b, 152c and 152d, configured at end portions of the straps 150a and 150b.

The pair of straps 150a and 150b are capable of being received through the plurality of securing slots configured on the first flange portion 118 and the second flange portion 138. More specifically, in the stacked arrangement of the first half casing 102 and the second half casing 106, the securing slots 148c and 148d configured on the second flange portion 138 align with the securing slots 128c and 128d configured on the first flange portion 118, respectively, for receiving the pair of straps 150a and 150b therethrough. For example, the strap 150a may be received through the securing slots 128a and 128d configured on the first flange portion 118 and through the securing slots 148a and 148d configured on the second flange portion 138. Similarly, the strap 150b may be received through the securing slots 128b and 128c configured on the first flange portion 118 and through the securing slots 148b and 148c configured on the second flange portion 138.

The pair of straps 150a and 150b received through the plurality of securing slots that are aligned, surrounds the first half casing 102 and the second half casing 106. Further, the connectors 152a and 152b configured at the end portions of the strap 150a are coupled to each other for coupling the end portions of the strap 150a. Similarly, the connectors 152c and 152d configured at the end portions of the strap 150b are coupled to each other for coupling the end portions of the strap 150b. When the respective end portions of the straps 150a and 150b are coupled, the fishing platform 100 attains the closed state as shown in FIG. 2. In the closed state of the fishing platform 100, the foldable sitting arrangement 104 is received in the hollow space 122 of the first half casing 102. Further, the support arrangement 110 may also be placed in the hollow space 122 of the first half casing 102 in the closed state of the fishing platform 100 after detaching the support arrangement 110 from the first flange portion 118.

As shown in FIG. 1, in one embodiment of the present disclosure, the support arrangement 110 includes a pair of support inserts 154a and 154b adapted to be mounted on the first flange portion 118, and a support insert connector 156 coupled to the pair of support inserts 154a and 154b. More specifically, each of the pair of support inserts 154a and 154b may be hollow elongated bolt like structure, capable of being received through a pair of holes (not shown) configured on the first flange portion 118. Further, the support insert connector 156 may be U-shaped bar like structure, capable of being received in the pair of support inserts 154a and 154b. The support arrangement 110 is capable of being rested on a shore area, when the first half casing 102 and the second half casing 106 are placed juxtaposed on the shore area (described in conjunction with FIG. 4), for allowing the first half casing 102 to be leveled with respect to a surface of the shore area. The support arrangement 110 of the present embodiment is capable of retaining the first half casing 102 at a fixed height from the surface of the shore area.

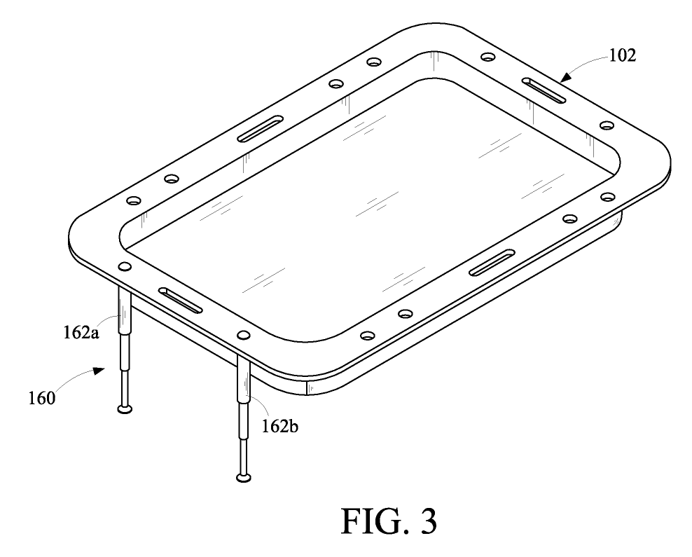

In another embodiment of the present disclosure, the fishing platform 100 includes a support arrangement such as a support arrangement 160 that is capable of allowing in adjusting a height of the first half casing 102 with respect to the surface of the shore area. Referring to FIG. 3, a perspective view of the first half casing 102 with the support arrangement 160 is illustrated, in accordance with this embodiment of the present disclosure. The support arrangement 160 includes one or more telescopic support members, such as telescopic support members 162a and 162b, adapted to be mounted on the first flange portion 118. The telescopic support members 162a and 162b are capable of being moved telescopically for adjusting heights thereof. The telescopic support members 162a and 162b are capable of adjusting a height between the first flange portion 118 of the first half casing 102 and the surface of the shore area when the fishing platform 100 is placed during a fishing activity, as shown in FIG. 4.

Referring now to FIG. 4, an environment representing the fishing platform 100 being utilized during a fishing activity is illustrated, in accordance with an embodiment of the present disclosure. In the present embodiment, the fishing platform 100 is shown utilized in the fishing activity with the help of a fishing rod 200. The fishing platform 100 is placed in the open state on a shore area 202, where the first half casing 102 and the second half casing 106 are placed juxtaposed to each other. More specifically, the first half casing 102 and the second half casing 106 are placed adjacent to each other with the first base portion 112 of the first half casing 102 and the second base portion 130 of the second half casing 106 being placed on a surface 204 of the shore area 202.

Further, when the first half casing 102 is positioned on the surface 204 of the shore area 202, the first half casing 102 may be leveled with respect to the surface 204 of the shore area 202. More specifically, the support insert connector 156 of the support arrangement 110 is capable of being rested on the surface 204 of the shore area 202 to balance the first half casing 102 on the surface 204 of the shore area 202. Generally a surface, such as the surface 204 of a shore area, such as the shore area 202 has a downward slop. Accordingly, the support arrangement 110 of the fishing platform 100 enables the first half casing 102 of the fishing platform 100 to be supported at an angle with respected to the surface 204 of the shore area 202 and thereby allowing the first half casing 102 to be resting in a horizontal line. The support arrangement 110 enables in retaining the first half casing 102 at the fixed height from the surface 204, and the support arrangement 160 enables in adjusting the height between the first half casing 102 and the surface 204.

Furthermore, when the first half casing 102 is leveled with the surface 204 of the shore area 202, the foldable sitting arrangement 104 is allowed to attain the unfolded state on the first base portion 112 of first half casing 102. The foldable sitting arrangement 104 in the unfolded state thereof allows an individual 300 to be seated during the fishing activity.

Further, the plurality of articles associated with the fishing activity such as a fishing rod holder 206, an umbrella holder 208, and a drink holder 210 may be held by the plurality of mounting slots configured on the first flange portion 118 of the first half casing 102. For example, the fishing rod holder 206, the umbrella holder 208, and the drink holder 210 are held by the mounting slots 124d, 124c and 124b, respectively.

The individual 300 may further mount an umbrella 212 into the umbrella holder 208 for protection against climate factors, such as sunlight and rain. Further, the individual 300 may rest the fishing rod 200 in the fishing rod holder 206 for freeing his/her arms during the fishing activity. Furthermore, the individual 300 is capable of holding a drink in the drink holder 210 during the fishing activity. Accordingly, the use of the fishing rod holder 206, the umbrella holder 208, and the drink holder 210 provides a pleasant fishing experience to the individual 300. Additionally, the compartments 136a, 136b, 136c and 136d of the second half casing 106 are adapted to store the plurality of articles associated with the fishing activity. Such plurality of articles may include, but are not limited to, a flashlight 214, a creel 216, and a radio 218, stored in the compartments 136a, 136b, 136c and 136d, respectively. The use of such articles, i.e., the flashlight 214, the creel 216, and the radio 218 may make the fishing activity enjoyable.

At the end of the fishing activity, the plurality of articles associated with the fishing activity, such as the fishing rod 200, the fishing rod holder 206, the umbrella holder 208, the drink holder 210, the umbrella 212, the flashlight 214, the creel 216, and the radio 218 may be stored in the compartments 136a, 136b, 136c and 136d of the second half casing 106. The compartments 136a, 136b, 136c and 136d provide a systematic arrangement for storing and accessing of the plurality of articles. The first half casing 102 and the second half casing 106 may be further secured to each other with the help of the securing mechanism 108 for allowing the fishing platform 100 to attain the closed state for being carried form the shore area 202.

Based on the foregoing description of the present disclosure, it would be apparent to those skilled in the art that a fishing platform, such as the fishing platform 100 is capable of providing a pleasant fishing experience to an individual. More specifically, the fishing platform of the present disclosure enables the individual to be seated during a fishing activity and thereby reduces a tiring and boring aspect associated with the fishing activity. Further, the fishing platform is capable of storing a plurality of articles associated with the fishing activity and accordingly provides easy accessibility to the plurality of articles for being used during the fishing activity. The structure design of the fishing platform enables an individual to easily carry the fishing platform form one place to another place and to store the fishing platform in a limited space.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, to thereby enable others skilled in the art to best utilize the present disclosure and various embodiments with

[symbol]

What is claimed is:

1. A fishing platform, comprising:
a first half casing comprising a first base portion, a first projecting portion extending from a periphery of the first base portion to define a hollow space between the first base portion and the first projecting portion;
a foldable sitting arrangement adapted to be received in the hollow space and disposed on the first base portion of the first half casing;
a second half casing comprising a second base portion, a second projecting portion extending from a periphery of the second base portion and a plurality of compartments configured between the second base portion and second projecting portion, the plurality of compartments adapted to store a plurality of articles associated with a fishing activity; and
a securing mechanism adapted to removably secure the first half casing to the second half casing in a stacked arrangement of the first half casing and the second half casing for allowing the fishing platform to attain one of an open state of the fishing platform and a closed state of the fishing platform,
wherein in the open state of the fishing platform, the first half casing and the second half casing are capable of being placed juxtaposed to each other on a shore area with the sitting arrangement in an unfolded state for allowing an individual to be seated for the fishing activity, and
wherein in the closed state of the fishing platform, the first half casing and the second half casing are secured to each other in the stacked arrangement of the first half casing and the second half casing with the seating arrangement in the folded state and confined in the hollow space.

2. The fishing platform of claim 1, further comprising a first flange portion extending from a top end portion of the first projecting portion, and a second flange portion extending from a top end portion of the second projecting portion, wherein each of the first flange portion and the second flange portion comprises a plurality of mounting slots configured thereon, each of the plurality of mounting slots adapted to hold at least one article associated with the fishing activity.

3. The fishing platform of claim 2, wherein the at least one article comprises at least one of a fishing rod holder, an umbrella holder, and a drink holder.

4. The fishing platform of claim 2, wherein each of the first flange portion and the second flange portion further comprises a plurality of carrying slots configured thereon, the plurality of carrying slots enabling the individual in carrying the fishing platform from one place to another.

5. The fishing platform of claim 2, wherein each of the first flange portion and the second flange portion further comprises a plurality of securing slots configured thereon, the plurality of securing slots enabling in securing the first half casing with the second half casing.

6. The fishing platform of claim 5, wherein the securing mechanism comprises a pair of straps and a plurality of connectors configured at end portions of each of the pair of straps, the pair of straps capable of being received through the plurality of securing slots for surrounding the first half casing and the second half casing and the plurality of connectors coupling the end portions of each of the pair of straps for securing the first half casing with the second half casing for allowing the fishing platform to attain the closed state.

7. The fishing platform of claim 2, further comprising a support arrangement adapted to be mounted on the first flange portion, the support arrangement capable of being rested on the shore area for allowing the first half casing to be leveled with respect to a surface of the shore area.

8. The fishing platform of claim 7, wherein the support arrangement comprises one or more telescopic support members adapted to be mounted on the first flange portion, the one or more telescopic support members capable of adjusting a height between the first half casing and the surface.

9. The fishing platform of claim 1, wherein the seating arrangement comprises a foldable chair.
